(19) United States
(12) Patent Application Publication
(10) Pub. No.: US 2022/0268928 A1
(43) Pub. Date: Aug. 25, 2022

(54) APPARATUS FOR SELECTING LIDAR TARGET SIGNAL, LIDAR SYSTEM HAVING THE SAME, AND METHOD THEREOF

(71) Applicants: HYUNDAI MOTOR COMPANY, Seoul (KR); Kia Corporation, Seoul (KR)

(72) Inventors: Eun Sang LEE, Seongnam-si (KR); Yong Sung LEE, Seongnam-si (KR); Sang Gyu PARK, Suwon-si (KR); Woo Il LEE, Uiwang-si (KR)

(73) Assignees: HYUNDAI MOTOR COMPANY, Seoul (KR); Kia Corporation, Seoul (KR)

(21) Appl. No.: 17/471,814

(22) Filed: Sep. 10, 2021

(30) Foreign Application Priority Data
Feb. 25, 2021 (KR) 10-2021-0026001

(51) Int. Cl. G01S 17/00

(52) U.S. Cl. CPC G01S 17/006; G01S 17/931

(57) ABSTRACT

A Light Detection and Ranging (LiDAR) target signal selection apparatus may include a processor configured to estimate a target signal among signals of a current frame N by use of a determined target signal of a previous frame N−1 among N LiDAR receiving signals, and to determine the estimated target signal based on deviations of previous frames 1 to N−1; and a storage configured to store data and algorithms driven by the processor.

### CROSS-REFERENCE TO RELATED APPLICATION

The present application claims priority to Korean Patent Application No. 10-2021-0026001 filed on Feb. 25, 2021, the entire contents of which is incorporated herein for all purposes by this reference.

### BACKGROUND OF THE INVENTION

### Field of the Invention

The present invention relates to a Light Detection and Ranging (LiDAR) target signal selection apparatus, a LiDAR system including the same, and a method thereof, and more particularly to a technique for selecting a target signal of a LiDAR to which a silicon photomultiplier (SiPM) is applied.

### Description of Related Art

A radar is a sensor that measures a distance by transmitting a laser and measuring a time of the laser reflected by a target.

A radar with a silicon photomultiplier (SiPM) has a very good characteristic of sensitivity of a reflected incoming signal, and it has a characteristic which is sensitive to solar noise, and it is a major cause of performance degradation when noise is not accurately removed from a signal processor of a receiving end.

A motor-scan type of radar based on the SiPM requires a large amount of computation because it needs to perform calculations such as signal reception, noise removal, and distance detection in a short time period to detect a laser during a given angle of view.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a LiDAR target signal selection apparatus, a LiDAR system including the same, and a method thereof, configured for effectively removing noise from a LiDAR to which a silicon photomultiplier is applied and minimizing an amount of computation for detecting a target signal to reduce a manufacturing cost of the LiDAR.

The technical objects of the present invention are not limited to the objects mentioned above, and other technical objects not mentioned may be clearly understood by those skilled in the art from the description of the claims.

Various aspects of the present invention are directed to providing a LiDAR target signal selection apparatus including a processor configured to estimate a target signal among signals of a current frame N by use of a determined target signal of a previous frame N−1 among N LiDAR receiving signals, and to determine the estimated target signal based on deviations of previous frames 1 to N−1; and a storage configured to store data and algorithms driven by the processor.

In various exemplary embodiments of the present invention, the processor may determine an Euclidean distance between the determined target signal of the previous frame N−1 and the signals of the current frame N.

In various exemplary embodiments of the present invention, the processor may estimate a signal having a lowest Euclidean distance among the signals of the current frame N as the target signal.

In various exemplary embodiments of the present invention, the processor may determine deviations of the previous frames 1 to N−1, and may determine an average value of each of the deviations.

In various exemplary embodiments of the present invention, the processor may set a deviation average boundary range by extending it in a (+) direction and a (−) direction by an average value of the deviations based on a magnitude of the determined target signal of the previous frame N−1.

In various exemplary embodiments of the present invention, the processor may determine whether the estimated target signal of the current frame N is within the deviation average threshold range.

In various exemplary embodiments of the present invention, the processor may determine the estimated target signal of the current frame N when the processor concludes that the estimated target signal of the current frame N is within the deviation average boundary range.

Various aspects of the present invention are directed to providing a LiDAR system including: a light-transmitting signal processor configured to transmit a laser to a target; a light-receiving signal processor configured to detect light reflected back from the target; a LiDAR target signal selection apparatus configured to estimate a target signal among signals of a current frame N by use of a determined target signal of a previous frame N−1 among N LiDAR receiving signals received by the light-receiving signal processor, and to determine the estimated target signal based on deviations of previous frames 1 to N−1; and a point cloud configured to output a distance value of the target signal determined by the LiDAR target signal selection apparatus in 3D graphics.

In various exemplary embodiments of the present invention, it may further include a scan motor configured to transmit the laser to various angles of view.

In various exemplary embodiments of the present invention, the LiDAR target signal selection apparatus may determine an Euclidean distance between the determined target signal of the previous frame N−1 and the signals of the current frame N.

In various exemplary embodiments of the present invention, the LiDAR target signal selection apparatus may estimate a signal having a lowest Euclidean distance among the signals of the current frame N as the target signal.

In various exemplary embodiments of the present invention, the LiDAR target signal selection apparatus may determine deviations of the previous frames 1 to N−1, may determine an average value of each of the deviations, and may set a deviation average boundary range by extending it in a (+) direction and a (−) direction by an average value of the deviations based on a magnitude of the determined target signal of the previous frame N−1.

In various exemplary embodiments of the present invention, the LiDAR target signal selection apparatus may determine whether the estimated target signal of the current frame N is within the deviation average boundary range, and may determine the estimated target signal of the current frame N when the processor concludes that the estimated target signal of the current frame N is within the deviation average boundary range.

Various aspects of the present invention are directed to providing a LiDAR target signal selection method including: transmitting a laser signal to a target; detecting a signal reflected back from the target; estimating a target signal among signals of a current frame N by use of a determined target signal of a previous frame N−1 among N LiDAR receiving signals; determining the estimated target signal based on deviations of previous frames 1 to N−1.

In various exemplary embodiments of the present invention, the estimating of the target signal may include determining an Euclidean distance between the determined target signal of the previous frame N−1 and the signals of the current frame N.

In various exemplary embodiments of the present invention, the estimating of the target signal may further include estimating a signal having a lowest Euclidean distance among the signals of the current frame N as the target signal.

In various exemplary embodiments of the present invention, the determining of the estimated target signal may include determining the deviations of the previous frames 1 to N−1, and determining an average value of each of the deviations.

In various exemplary embodiments of the present invention, the determining of the estimated target signal may include setting a deviation average boundary range by extending it in a (+) direction and a (−) direction by an average value of the deviations based on a magnitude of the determined target signal of the previous frame N−1.

In various exemplary embodiments of the present invention, the determining of the estimated target signal may further include determining whether the estimated target signal of the current frame N is within the deviation average threshold range.

In various exemplary embodiments of the present invention, the determining of the estimated target signal may further include determining the estimated target signal of the current frame N when the processor concludes that the estimated target signal of the current frame N is within the deviation average boundary range.

According to the present technique, it is possible to effectively remove noise from a LiDAR to which a silicon photomultiplier is applied and to minimize an amount of computation for detecting a target signal to reduce a manufacturing cost of the LiDAR.

Furthermore, various effects which may be directly or indirectly identified through the present specification may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram showing a configuration of a LiDAR system including a LiDAR target signal selection apparatus according to various exemplary embodiments of the present invention.

FIG. 2 illustrates a view for describing LiDAR principle according to various exemplary embodiments of the present invention.

FIG. 3A illustrates a view for describing responsiveness of a silicon photomultiplier according to various exemplary embodiments of the present invention.

FIG. 3B illustrates a view for describing an output characteristic of a silicon photomultiplier according to various exemplary embodiments of the present invention.

FIG. 4 illustrates a process of estimating a LiDAR target signal according to various exemplary embodiments of the present invention.

FIG. 5 illustrates a view for describing a process of estimating LiDAR target signal according to various exemplary embodiments of the present invention.

FIG. 6 illustrates an example of an Euclidean distance technique during a process of estimating LiDAR target signal according to various exemplary embodiments of the present invention.

FIG. 7 illustrates a process of determining a LiDAR target signal according to various exemplary embodiments of the present invention.

FIG. 8 illustrates a view for describing a process of determining a LiDAR target signal according to various exemplary embodiments of the present invention.

FIG. 9 illustrates an example of an Euclidean distance technique during a process of determining LiDAR target signal according to various exemplary embodiments of the present invention.

FIG. 10 illustrates a flowchart for describing a LiDAR target signal selection method according to various exemplary embodiments of the present invention.

FIG. 11 illustrates a computing system according to various exemplary embodiments of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Hereinafter, some exemplary embodiments of the present invention will be described in detail with reference to exemplary drawings. It may be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to various exemplary embodiments of the present invention, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which various exemplary embodiments of the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

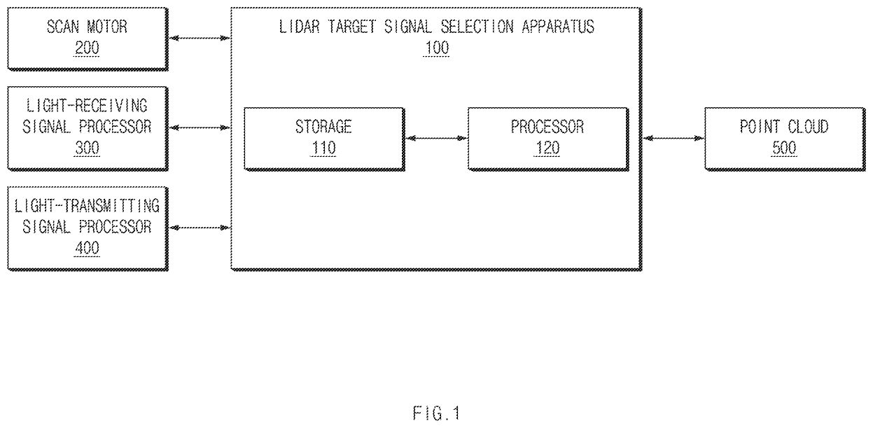

Hereinafter, various exemplary embodiments of the present invention will be described in detail with reference to FIG. 1 to FIG. 11.

FIG. 1 illustrates a block diagram showing a configuration of a LiDAR system including a LiDAR target signal selection apparatus according to various exemplary embodiments of the present invention.

Referring to FIG. 1, the LiDAR system according to the exemplary embodiment of the present invention may include a LiDAR target signal selection apparatus 100, a scan motor 200, a light-receiving signal processor 300, a light-transmitting signal processor 400, and a point cloud 500.

The LiDAR target signal selection apparatus 100 according to various exemplary embodiments of the present invention may be implemented inside a LiDAR system, and the LiDAR system may be implemented inside a vehicle. In the instant case, the LiDAR target signal apparatus 100 and the LiDAR system may be integrally formed with internal control units of the vehicle, or may be implemented as a separate device to be connected to control units of the vehicle by a separate connection means.

The LiDAR target signal selection apparatus 100 may estimate a target signal among signals of a current frame N by use of a determined target signal of a previous frame N−1 among N LiDAR receiving signals, and may determine the estimated target signal based on deviations of previous frames 1 to N−1. To the present end, the LiDAR target signal selection apparatus 100 may estimate the target signal using an Euclidean distance technique, and may determine the estimated target signal as the final target signal by use of the deviations of the determined target signals of the previous frame and an average value thereof.

Referring to FIG. 1, the LiDAR target signal selection apparatus 100 may include a storage 110 and a processor 120.

The storage 110 may store data or algorithms required for the processor 120 to operate, and the like. As an example, the storage 110 may store data and algorithms for estimating and determining a LiDAR target signal. Furthermore, the storage 150 may store light-receiving signal data received by the light-receiving signal processor 300.

The storage 110 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 120 may be electrically connected to the scan motor 200, the light-receiving signal processor 300, the light-transmitting signal processor 400, the point cloud 500, and the like, may electrically control each component, and may be an electrical circuit that executes software commands, performing various data processing and calculations described below.

The processor 120 may process signals transferred between constituent elements of the LiDAR target signal selection apparatus 100. The processor 120 may perform control such that each component may normally perform a function thereof. The processor 120 may be implemented in a form of hardware, software, or a combination of hardware and software. For example, the processor 120 may be implemented as a microprocessor, but the present invention is not limited thereto.

The processor 120 may remove noise by selecting only a signal having a predetermined level or higher among signals received by the light-receiving signal processor 300 through threshold voltage control, and may accurately extract only a desired target signal. In the instant case, a threshold voltage may be predetermined or varied by experimental values.

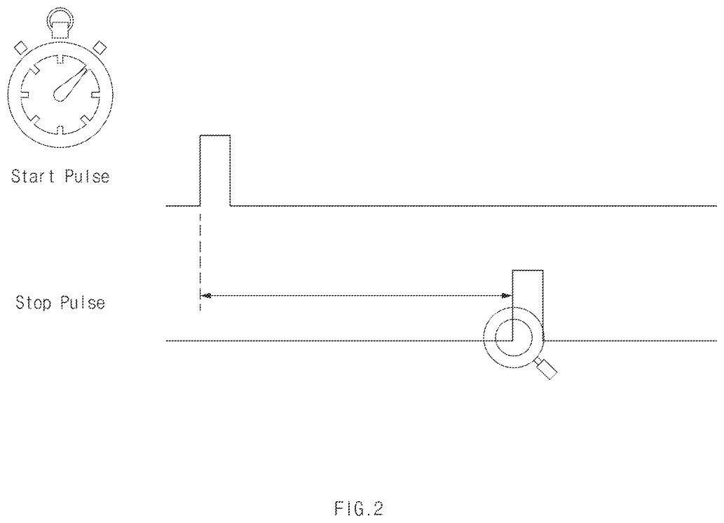

The processor 120 may determine a distance to a target based on a time when the light-transmitting signal is reflected by the target and returned. FIG. 2 illustrates a view for describing LiDAR principle according to various exemplary embodiments of the present invention. Referring to FIG. 2, a LiDAR-based distance calculation method is converted into distance information through time measurement between Start Pulse Stop Pulse.

Equation 1 below is an equation for determining the distance information.

Distance information [m]=(photon speed [m/s]×time [s])/2 (Equation 1)

For example, when the detection time of a LiDAR signal is 6.667 ns, it may be determined as the distance=(3×10\hat{ }8*6.667×10\hat{ }−9)/2=1 m.

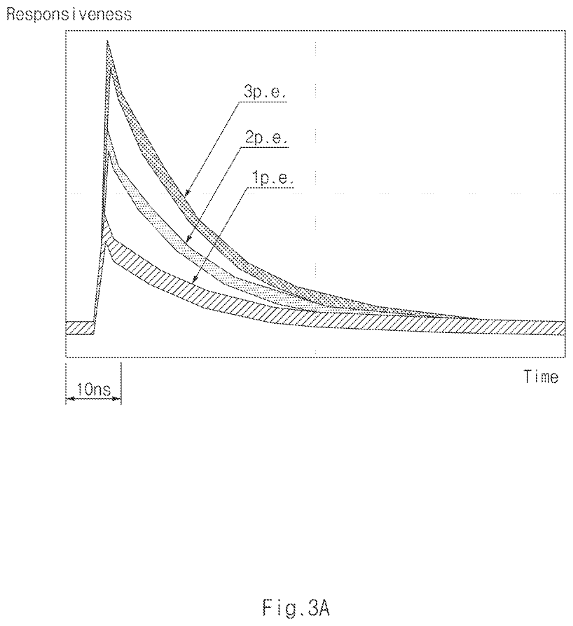

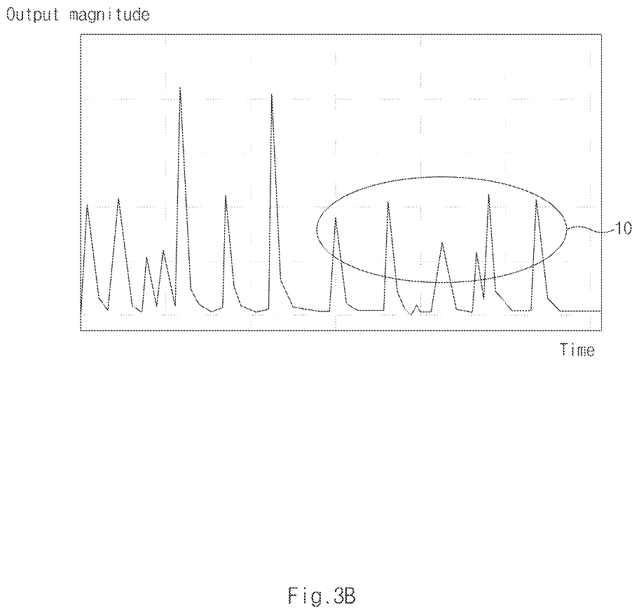

FIG. 3A illustrates a view for describing responsiveness of a silicon photomultiplier according to various exemplary embodiments of the present invention, and FIG. 3B illustrates a view for describing an output characteristic of a silicon photomultiplier according to various exemplary embodiments of the present invention. Referring to FIG. 3A, a detection level is varied depending on a number of photons of the silicon photomultiplier, and is expressed as 1 p.e. (photon detection efficiency) 2 p.e., 3 p.e.

The silicon photomultiplier has excellent sensitivity because detection is possible by one photonic sensor, but instead, probability of detecting optical noise 10 as illustrated in FIG. 3B is also increased. It is necessary to effectively remove such optical noise and accurately detect a target signal.

Accordingly, the processor 120 may estimate a target signal among signals of a current frame N by use of a determined target signal of a previous frame N−1 among N LiDAR receiving signals, and may determine the estimated target signal based on deviations of previous frames 1 to N−1.

Furthermore, the processor 120 may determine an Euclidean distance between the determined target signal of the previous frame N−1 and the signals of the current frame N, and may estimate a signal having a lowest Euclidean distance among the signals of the current frame N as the target signal.

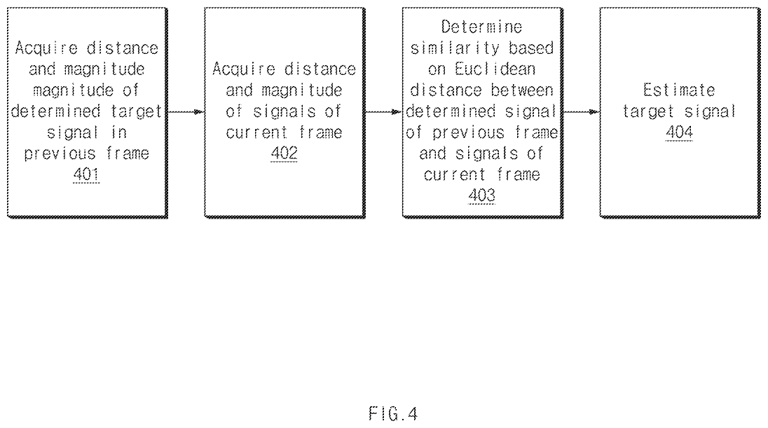

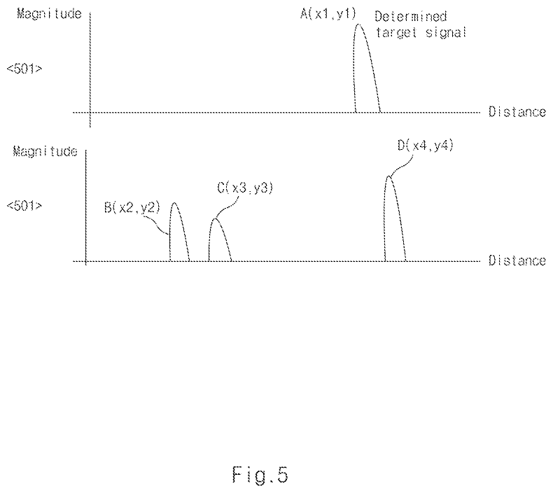

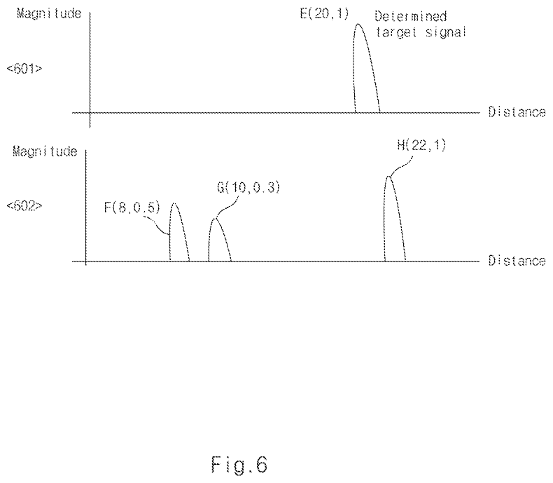

FIG. 4 illustrates a process of estimating LiDAR target signal according to various exemplary embodiments of the present invention, FIG. 5 illustrates a view for describing a process of estimating LiDAR target signal according to various exemplary embodiments of the present invention, and FIG. 6 illustrates an example of an Euclidean distance technique during a process of estimating LiDAR target signal according to various exemplary embodiments of the present invention.

A high-sensitivity light-transmitting and receiving has no big problem because a reflected light output of the target is relatively high compared to noise when the target is in a short distance, but a level (magnitude) of the reflected light output and noise are similar when the target is in a long distance, so there is a high probability that they cannot be distinguished.

Accordingly, in various exemplary embodiments of the present invention, the target signal among the signals of a current frame may be estimated by use of the determined target signal detected from a signal of a previous frame. This is because even in a state in which the target signal is in motion, the current target signal is highly likely to be detected as a position that does not deviate significantly from a position of the final target signal detected in the signal of the previous frame.

Referring to FIG. 4, the LiDAR target signal selection apparatus 100 measures a distance and a magnitude of a determined target signal in a previous frame (401). As shown in a region 501 of FIG. 5, coordinates (x1, y1) of the determined target signal an in the previous frame are extracted.

Accordingly, the LiDAR target signal selection device 100 acquires the distance and size of signals of the current frame. As shown in a region 502 of FIG. 5, coordinates (x2, y2), (x3, y3), and (x4, y4) of signals B, C, and D in the current frame are extracted.

The LiDAR target signal selection apparatus 100 determines a similarity based on an Euclidean distance between the determined signal of the previous frame and the signals of the current frame (403).

In the instant case, the Euclidean distance method is a method that defines and expresses the similarity between two data based on distance. For example, when there are two points (p1, p2, . . . , and pn), (q1, q2, . . . , and qn), the distance representing the similarity between the two points may be expressed as Equation 2 below.

∥p−q∥=\sqrt{(p−q)·(p−q)}=\sqrt{∥p∥²+∥q∥²−2p·q}. (Equation 2)

Referring to FIG. 6, for example, when coordinates of a determined target signal E in a signal 601 of the previous frame are (20, 1) and coordinates of signals 602 of the current frame are F(8,0.5), G(10, 0.3), and H(22,1), Euclidean similarity is measured as in Equation 3 below.

E:\sqrt{(20−8)²+(1−0.5)²}=\sqrt{144.25}

F:\sqrt{(20−10)²+(1−0.3)²}=\sqrt{100.49}

G:\sqrt{(20−22)²+(1−1)²}=2 (Equation 3)

As in Equation 3, a signal G having a shortest Euclidean distance between the determined target signal and signals of the current frame may be determined to have highest similarity.

Accordingly, the processor 120 may estimate the signal G having the highest similarity as the target signal in the current frame.

Subsequently, the processor 120 may determine deviations of the previous frames 1 to N−1, and may determine an average value of each of the deviations to determine the estimated target signal. Furthermore, the processor 120 may set a deviation average boundary value range by extending in a (+) direction and a (−) direction by an average value of the deviations based on a magnitude of the determined target signal of the previous frame N−1.

Subsequently, the processor 120 may determine whether the estimated target signal of the current frame N is within the deviation average boundary range, and may determine the estimated target signal of the current frame N when the processor concludes that the estimated target signal of the current frame N is within the deviation average boundary range.

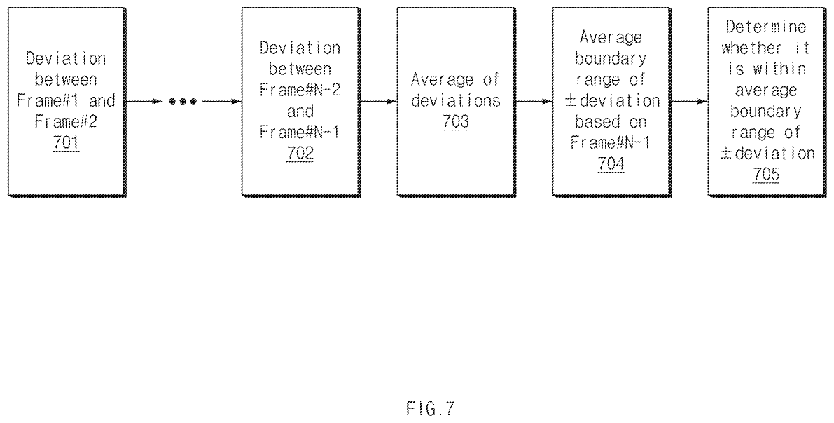

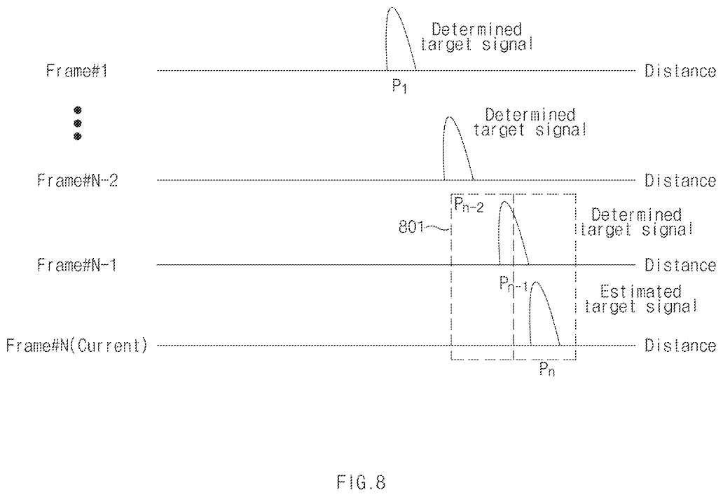

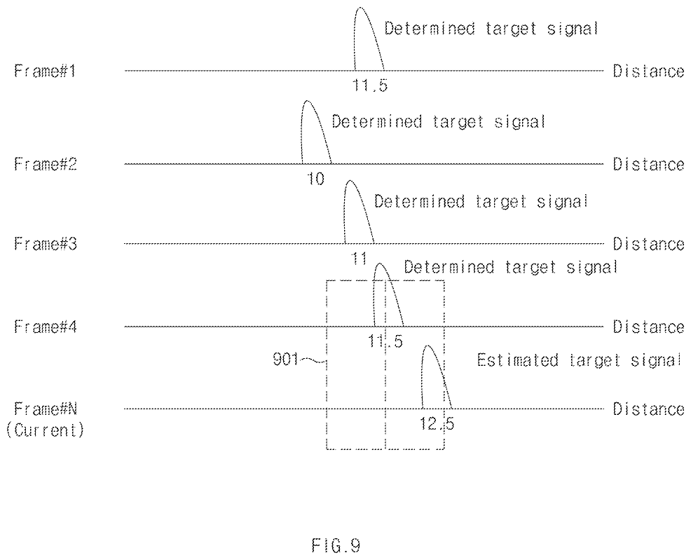

FIG. 7 illustrates a process of determining a LiDAR target signal according to various exemplary embodiments of the present invention, FIG. 8 illustrates a view for describing a process of determining a LiDAR target signal according to various exemplary embodiments of the present invention, and FIG. 9 illustrates an example of a Euclidean distance technique during a process of determining LiDAR target signal according to various exemplary embodiments of the present invention.

The LiDAR target signal selection apparatus 100 determines the target signal using the determined target signals of the previous frames to determine the target signal.

Referring to FIG. 7, the LiDAR target signal selection apparatus 100 measures deviations of the determined target signals of previous frames (701 and 702), and determines an average of the deviations (703).

Deviation between frame #1 and frame #2=P₁−P₂

. . .

Deviation between frame #N−2 and frame #N−1=P_{N-2}−P_{N-1} (Equation 4)

As shown in Equation 4, deviations between the determined target signals of each frame from the previous frame may be obtained, and an average of the deviations may be determined.

Subsequently, the LiDAR target signal selection apparatus 100 may set the deviation average boundary range by use of the average of the deviations (704). Referring to FIG. 8, the LiDAR target signal selection apparatus 100 may determine average values of each of the determined target signals of the previous frames Frame #1 to Frame #(N−1) and the deviations P1 to P(N−1), and may set an average boundary range 801 of ±deviation by moving them by a deviation average in the (+) and (−) directions based on the deviation P_{N-1}.

Next, the LiDAR target signal selection apparatus 100 determines whether the estimated target signal of the current frame #N is included in the deviation average boundary range 801 (705).

That is, when the signals of the previous frames are defined as ‘Frame #1 to Frame #(N−1)’ and the signal of the current frame is defined as Frame #N, the LiDAR target signal selection apparatus 100 measures deviations of the determined target signals of Frame #1 to Frame #(N−1) and determine an average thereof, and then utilizes the average of the deviations to determine the target signal of Frame #N (current) based on the determined signal of the ‘Frame #N−1’

Referring to FIG. 9, for example, since the deviation of the determined target signal of frame #1 and frame #2 is 11.5−10=1.5, the deviation of the determined target signal of frame #2 and frame #3 is 11−10=1, the deviation of the determined target signal of frame #3 and frame #4 is 11.5−11=0.5, an average of each of the deviations 1.5, 1, and 0.5 will be 1, and since a magnitude of the final target signal of frame #4, which is the previous frame, is 11.5, when it is increased by 1 in the (+) and (−) directions from 11.5, a deviation average boundary range 901 is set in a range of 10.5 to 12.5.

Accordingly, a magnitude of the estimated target signal of frame #5, which is the current frame, is 12.5, and 12.5 is included within the previously set deviation average boundary range 901, the estimated target signal may be determined as the target signal.

The scan motor 200 steers a beam for transmitting a LiDAR signal at various angles of view.

The light-receiving signal processor 300 detects a light signal reflected back from the target.

The light-transmitting signal processor 400 transmits a laser to the target.

The point cloud 500 outputs distance information to the target as 3D graphics.

Accordingly, according to various exemplary embodiments of the present invention, when removing noise and detecting a target signal, it is possible to effectively remove solar noise and detect target signal based on target signal estimation and target signal determination by a LiDAR to which a silicon photomultiplier of a motor scan type is applied, which is subject to physical restrictions.

That is, according to various exemplary embodiments of the present invention, solar noise may be effectively removed by estimating the target signal of the current frame by applying the Euclidean distance technique based on the light-receiving signal (determined target signal) of the previous frame, the deviation average boundary range may be set from the determined signal of the previous frame by determining the average of the deviations of the determined light-receiving signals 1 to N−1 of the previous frame and using the value, and when the estimated target signal is within the deviation average boundary range, it is possible to minimize the amount of computation for target signal selection, accurately select target signals, and effectively remove noise by determining the estimated signal as the target.

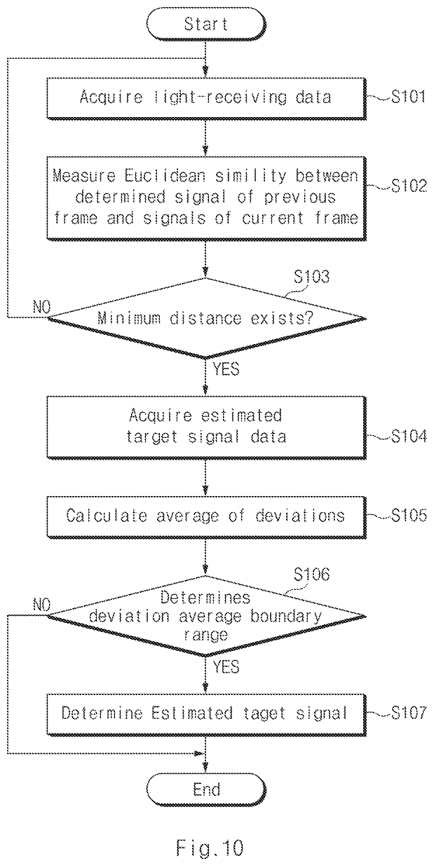

Hereinafter, a LiDAR target selection method according to various exemplary embodiments of the present invention will be described in detail with reference to FIG. 10. FIG. 10 illustrates a flowchart for describing a LiDAR target signal selection method according to various exemplary embodiments of the present invention.

Hereinafter, it is assumed that the LiDAR target signal selection 100 of the of FIG. 1 performs processes of FIG. 10. Furthermore, in the description of FIG. 10, operations referred to as being performed by a device may be understood as being controlled by the processor 120 of the LiDAR target signal selection apparatus 100.

Referring to FIG. 10, the LiDAR target selection apparatus 100 acquires light-receiving data (S101). That is, the LiDAR target signal selection apparatus 100 acquires a distance and a magnitude of a determined signal of a previous frame and a distance and a magnitude of a determined signal of a current frame.

Accordingly, the LiDAR target signal selection apparatus 100 measures an Euclidean distance between the predetermined signal of the previous frame and the determined signal of the current frame (S102).

Next, the LiDAR target signal selection apparatus 100 determines whether a current frame signal having a minimum Euclidean distance from a previous frame determined signal exists (S103), and when the current frame signal having the minimum Euclidean distance exists, the current frame signal is estimated as a target signal (S104).

The LiDAR target signal selection apparatus 100 determines the target signal using an estimated target signal. That is, the LiDAR target signal selection apparatus 100 measures deviations of the previous frame signals and then determines an average of the deviations (S105). For example, when the current frame is ‘Frame #N’, an average of deviations from ‘Frame #1’ to Frame #N−1’ is obtained.

Next, the LiDAR target signal selection apparatus 100 determines whether the target signal estimated from the current frame signal is within a deviation average boundary range by setting the deviation average boundary range (S106). That is, the LiDAR target signal selection apparatus 100 sets the deviation average boundary range by expanding it by the average value of deviation in the (+) and (−) directions based on ‘Frame #N−1’, and determines whether the estimated target signal in ‘Frame #N’ is within the set deviation average boundary range.

When the target signal estimated from the current frame signal is included within the deviation average boundary range, the LiDAR target signal selection apparatus 100 determines the corresponding target signal (S107).

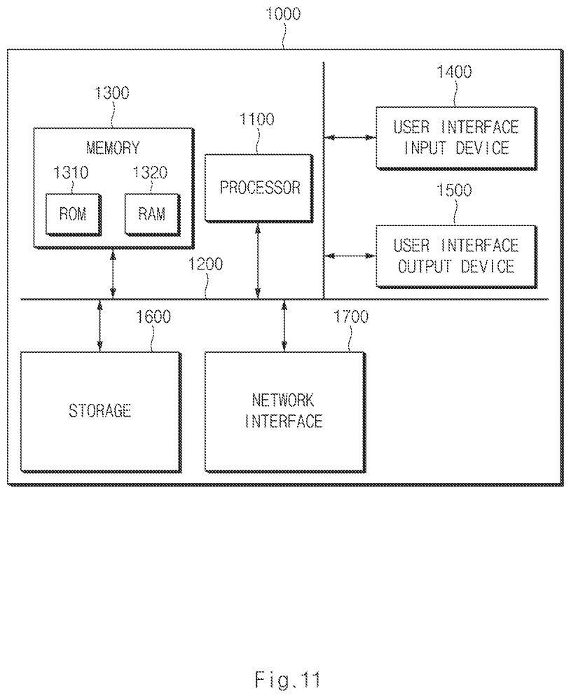

FIG. 11 illustrates a computing system according to various exemplary embodiments of the present invention.

Referring to FIG. 11, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present invention, and those skilled in the art to which various exemplary embodiments of the present invention pertains may make various modifications and variations without departing from the essential characteristics of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A Light Detection and Ranging (LiDAR) target signal selection apparatus comprising:
a processor configured to estimate a target signal among signals of a current frame N by use of a determined target signal of a previous frame N−1 among N LiDAR receiving signals, and to determine the estimated target signal based on deviations of previous frames 1 to N−1; and
a storage configured to store data and algorithms driven by the processor.

2. The LiDAR target signal selection apparatus of claim 1, wherein the processor is configured to determine an Euclidean distance between the determined target signal of the previous frame N−1 and the signals of the current frame N.

3. The LiDAR target signal selection apparatus of claim 2, wherein the processor is configured to estimate a signal having a lowest Euclidean distance among the signals of the current frame N as the target signal.

4. The LiDAR target signal selection apparatus of claim 1, wherein the processor is configured to determine the deviations of the previous frames 1 to N−1, and to determine an average value of each of the deviations.

5. The LiDAR target signal selection apparatus of claim 4, wherein the processor is configured to set a deviation average boundary range by extending the previous frame N−1 in a (+) direction and a (−) direction by the average value of the deviations based on a magnitude of the determined target signal of the previous frame N−1.

6. The LiDAR target signal selection apparatus of claim 5, wherein the processor is configured to determine whether the estimated target signal of the current frame N is within the deviation average boundary range.

7. The LiDAR target signal selection apparatus of claim 6, wherein the processor is configured to determine the estimated target signal of the current frame N when the processor concludes that the estimated target signal of the current frame N is within the deviation average boundary range.

8. A LiDAR system comprising:
a light-transmitting signal processor configured to transmit a laser to a target;
a light-receiving signal processor configured to detect light reflected back from the target;
a LiDAR target signal selection apparatus configured to estimate a target signal among signals of a current frame N by use of a determined target signal of a previous frame N−1 among N LiDAR receiving signals received by the light-receiving signal processor, and to determine the estimated target signal based on deviations of previous frames 1 to N−1; and
a point cloud configured to output a distance value of the target signal determined by the LiDAR target signal selection apparatus in 3D graphics.

9. The LiDAR system of claim 8, further including:
a scan motor configured to transmit the laser to various angles of view.

10. The LiDAR system of claim 8, wherein the LiDAR target signal selection apparatus is configured to determine an Euclidean distance between the determined target signal of the previous frame N−1 and the signals of the current frame N.

11. The LiDAR system of claim 10, wherein the LiDAR target signal selection apparatus is configured to estimate a signal having a lowest Euclidean distance among the signals of the current frame N as the target signal.

12. The LiDAR system of claim 8, wherein the LiDAR target signal selection apparatus is configured to determine the deviations of the previous frames 1 to N−1, to determine an average value of each of the deviations, and to set a deviation average boundary range by extending the previous frame N−1 in a (+) direction and a (−) direction by the average value of the deviations based on a magnitude of the determined target signal of the previous frame N−1.

13. The LiDAR system of claim 12, wherein the LiDAR target signal selection apparatus is configured to determine whether the estimated target signal of the current frame N is within the deviation average boundary range, and to determine the estimated target signal of the current frame N when a processor of the LiDAR target signal selection apparatus concludes that the estimated target signal of the current frame N is within the deviation average boundary range.

14. A Light Detection and Ranging (LiDAR) target signal selection method comprising:
transmitting a laser signal to a target;
detecting a signal reflected back from the target;
estimating, by a processor, a target signal among signals of a current frame N by use of a determined target signal of a previous frame N−1 among N LiDAR receiving signals;
determining, by the processor, the estimated target signal based on deviations of previous frames 1 to N−1.

15. The LiDAR target signal selection method of claim 14, wherein the estimating of the target signal includes determining an Euclidean distance between the determined target signal of the previous frame N−1 and the signals of the current frame N.

16. The LiDAR target signal selection method of claim 15, wherein the estimating of the target signal includes estimating a signal having a lowest Euclidean distance among the signals of the current frame N.

17. The LiDAR target signal selection method of claim 14, wherein the determining of the estimated target signal includes determining the deviations of the previous frames 1 to N−1, and determining an average value of each of the deviations.

18. The LiDAR target signal selection method of claim 17, wherein the determining of the estimated target signal includes setting a deviation average boundary range by extending the previous frame N−1 in a (+) direction and a (−) direction by the average value of the deviations based on a magnitude of the determined target signal of the previous frame N−1.

19. The LiDAR target signal selection method of claim 18, wherein the determining of the estimated target signal includes determining whether the estimated target signal of the current frame N is within the deviation average boundary range.

20. The LiDAR target signal selection method of claim 19, wherein the determining of the estimated target signal includes determining the estimated target signal of the current frame N when the processor concludes that the estimated target signal of the current frame N is within the deviation average boundary range.
